(19) United States
(12) Patent Application Publication
(10) Pub. No.: US 2007/0177346 A1
(43) Pub. Date: Aug. 2, 2007

(54) Externally connected hard disk drive controlled by mechanic lock having information security function

(76) Inventor: Nobuhiro Adachi, Sindian City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/341,422

(22) Filed: Jan. 30, 2006

(51) Int. Cl. G06F 1/16

(52) U.S. Cl. 361/685

(57) ABSTRACT

An externally connected hard disk drive includes a hard disk unit including a hard disk and a switch, and a mechanic lock. When the switch is turned on, the hard disk is accessible, and when the switch is turned off, the hard disk is not accessible. The mechanic lock includes a lock core and a mating key for rotating the lock core to an unlocked position where the switch is turned on and a locked position where the switch is turned off. Thus, by disconnecting either the power supply cord or the signal connecting line of the hard disk drive, we can prevent the information of the hard disk drive from being read or stolen.

### BACKGROUND OF THE INVENTION

1. Field of the Invention

The present invention relates to an externally connected hard disk drive, and more particularly to an externally connected hard disk drive controlled by a mechanic lock having information security and heat dissipating functions.

2. Description of the Related Art

A conventional externally connected hard disk drive in accordance with the prior art is disclosed in the Taiwanese Patent Publication No. 428642 and comprises a hard disk box and a removable hard disk mounted in the hard disk box. The hard disk box includes a mechanic lock to lock and/or unlock the removable hard disk. However, the information contained in the removable hard disk is easily read by a person when the removable hard disk is removed or stolen from the hard disk box.

Another prior art disclosed in the Taiwanese Patent Publication No. 570217 shown a technique of a portable key used to prevent the information of the hard disk drive from being read or stolen. However, such a technique requires the installation of a hard disk drive management module program to the computer, when the portable key is plugged in the USB port of the computer, the hard disk drive management program will verify the code within the portable key, and only when the code has been approved, will the information of the hard disk drive of the computer be accessed. Furthermore, Taiwanese Patent Publication No. 534413 also disclosed a similar technique, by applying an unlocking key and a locking device to protect the information of the hard disk drive of the computer. However, these conventional externally connected hard disk drives all have a complicated construction and need support of an software, thereby greatly increasing the price of the hard disk drive.

### SUMMARY OF THE INVENTION

The present invention is to mitigate and/or obviate the disadvantage of the conventional externally connected hard disk drive.

The primary objective of the present invention is to provide an externally connected hard disk drive controlled by a mechanic lock having an information security function. In particular, the mechanic lock comprises of a lock core, wherein the lock core is arranged to be turned by a key to an unlocked position where the switch is turned on and a locked position where the switch is turned off. The switch externally connected to the hard disk drive, and when the switch is turned on, the hard disk becomes accessible, and when the switch is turned off, it immediately disconnect the power supply of the hard disk or signal connected to the hard disk, preventing the hard disk from being accessed.

Comparing to the prior arts, the present invention has a simplified structure, and does not need software support. This shows that the above-described externally connected hard disk drive has a better information security function by a lower price.

Moreover, the present invention also provided another type of an externally connected hard disk drive comprised of the above-described mechanic lock and a cooling fan and the front board and the back board of the externally connected hard disk drive comprises of a plurality of vent holes respectively, dissipating heat by the cooling fan and those vent holes to equip the externally connected hard disk drive with better heat dissipating function.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of an externally connected hard disk drive in accordance with the preferred embodiment of the present invention;

FIG. 2 is a circuit diagram of the externally connected hard disk drive in accordance with the preferred embodiment of the present invention;

FIG. 3 is a circuit diagram of the externally connected hard disk drive in accordance with another preferred embodiment of the present invention; and

FIG. 4 is a rear plan view of the externally connected hard disk drive as shown in FIG. 1.

### DETAILED DESCRIPTION OF THE INVENTION

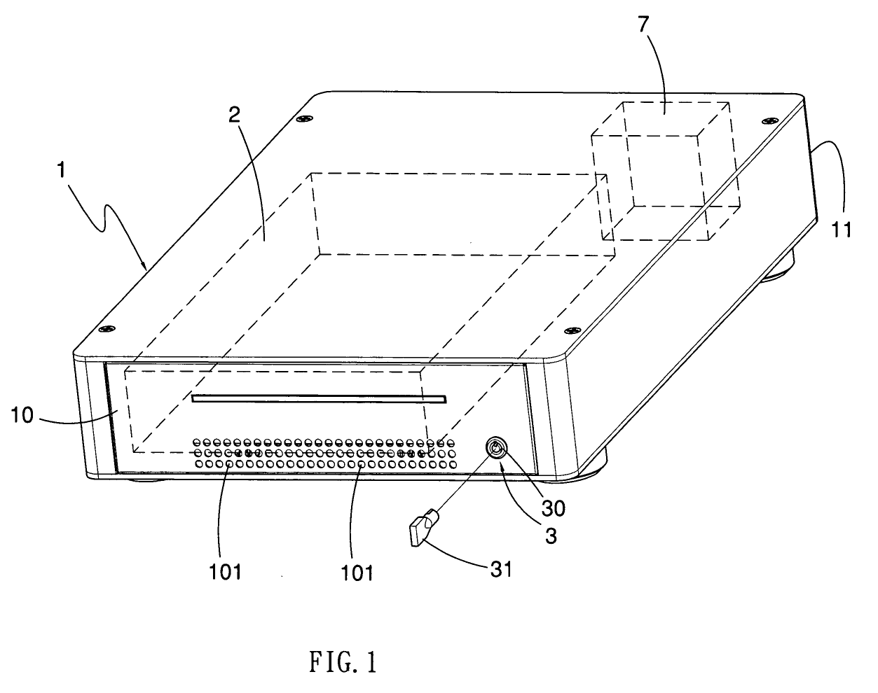

Referring to the drawings and initially to FIG. 1, an externally connected hard disk drive in accordance with the preferred embodiment of the present invention comprises a housing 1 having a front board 10 and a back board 11, a hard disk unit 2 mounted in the housing 1, and a mechanic lock 3 mounted on the housing 1 and including a lock core 30 mounted on the front board 10 of the housing 1 and a mating key 31 inserted into the lock core 30 for rotating the lock core 30.

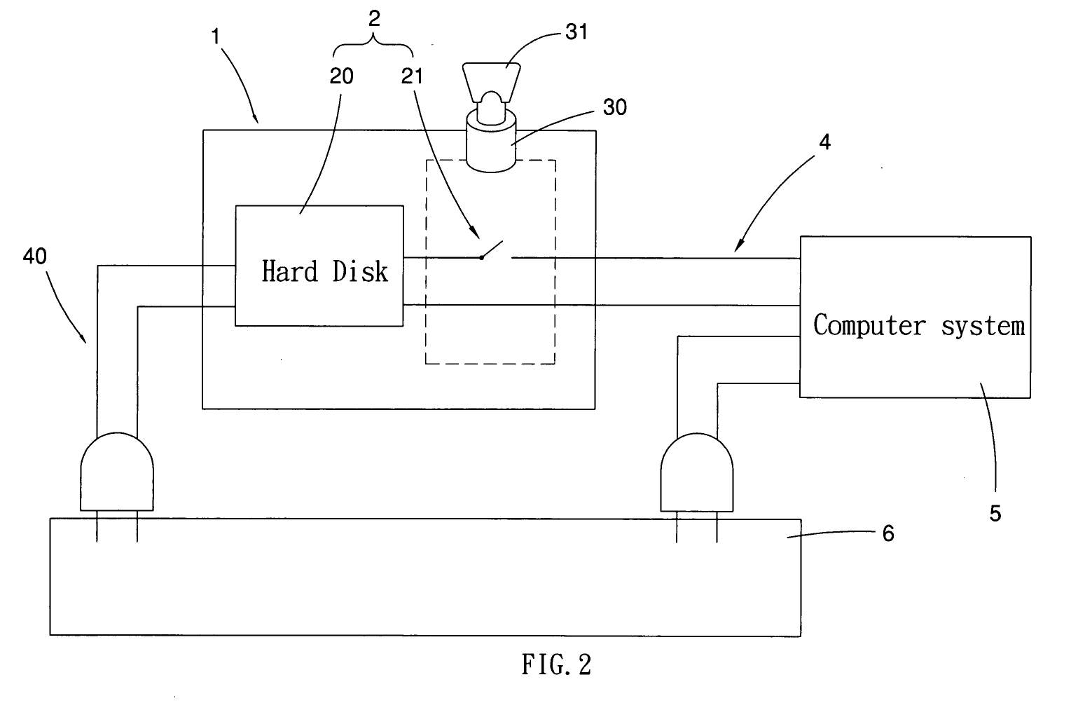

Referring to FIG. 2, the externally connected hard disk drive is connected to a computer system 5 by a signal line 4 and connected to a power supply 6 by an electric cord 40. The hard disk unit 2 includes a hard disk 20 and a switch 21. The power supply 6 supplies an electric power to the hard disk 20 by the electric cord 40. The hard disk 20 is connected to the computer system 5 by the switch 21 and the signal line 4. The switch 21 is an electronic switch or a mechanic switch. The signal line 4 is a connecting line of USB, SATA, PATA or IDE.

The lock core 30 is rotatable by the key 31 to an unlocked position where the switch 21 is turned on and a locked position where the switch 21 is turned off. When the switch 21 is turned on by the mechanic lock 3, the hard disk 20 is connected to the computer system 5, so that the computer system 5 can access the information of the hard disk 20 by the signal line 4 and the switch 21. As shown in FIG. 2, when the switch 21 is turned off by the mechanic lock 3, the connection between the hard disk 20 and the computer system 5 is interrupted, so that the computer system 5 cannot access the information of the hard disk 20.

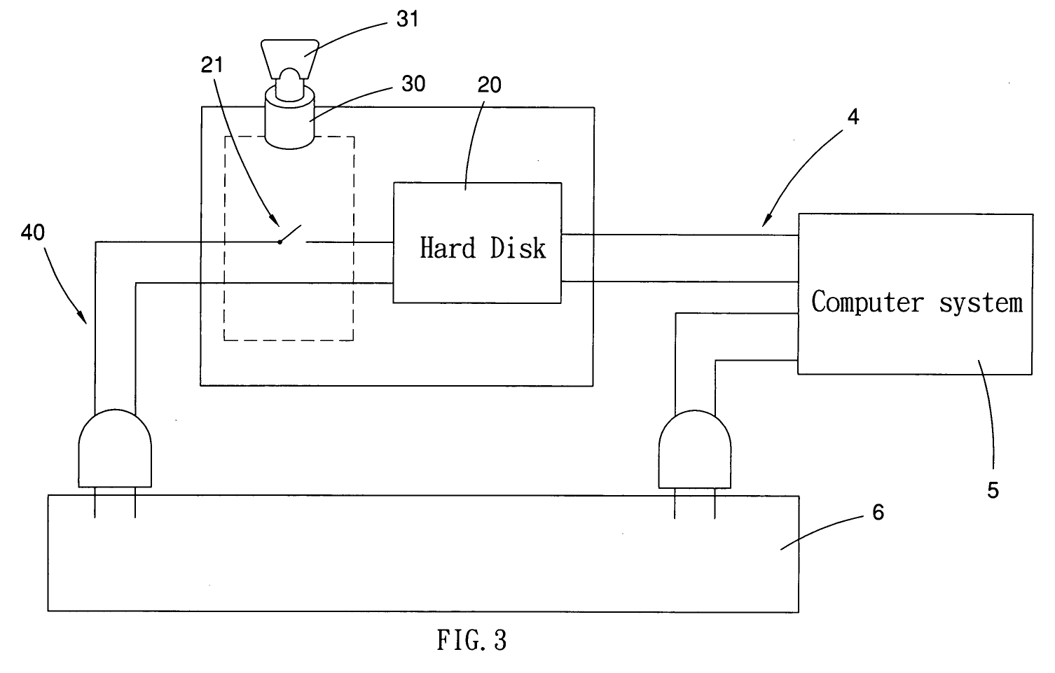

Referring to FIG. 3, the externally connected hard disk drive is similar to that as shown in FIG. 2, and the difference is in that, the power supply 6 supplies an electric power to the hard disk 20 by the electric cord 40 and the switch 21, and the hard disk 20 is constantly connected to the computer system 5 by the signal line 4. When the switch 21 is turned on by the relative motion between the lock core 30 and the key 31, the power supply 6 supplies an electric power to the hard disk 20 to start the hard disk 20, so that the computer system 5 can access the information of the hard disk 20 by the signal line 4. As shown in FIG. 3, when the switch 21 is turned off, the connection between the hard disk 20 and the power supply 6 is interrupted, so that the computer system 5 cannot access the information of the hard disk 20.

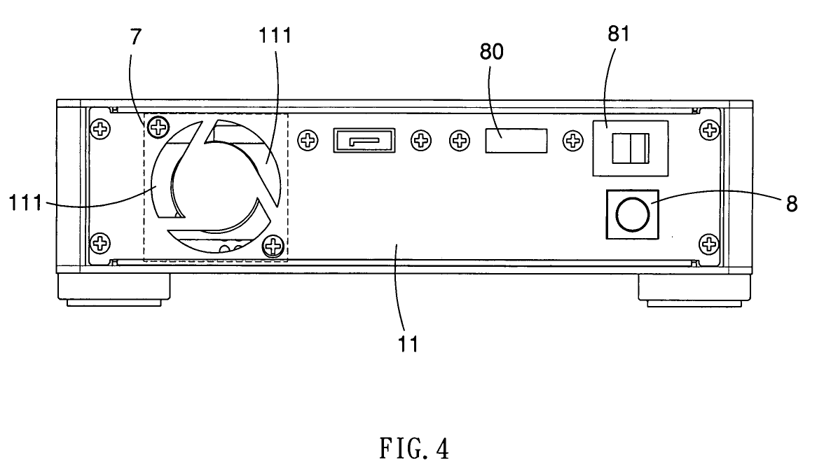

Referring to FIG. 4, the externally connected hard disk drive further comprises an electric socket 8 mounted on the back board 11 of the housing 1 and connected to the electric cord 40, an interface adapter 80 mounted on the back board 11 of the housing 1 and connected to the signal line 4, and a push button 81 mounted on the housing 1 to control the power supply. As shown in FIG. 2, the switch 21 is bridged between the hard disk 20 and the interface adapter 80. As shown in FIG. 3, the switch 21 is bridged between the hard disk 20 and the electric socket 8.

In conclusion, the lock core 30 is rotatable by the key 31 to unlock the hard disk 20 so that the computer system 5 can access the information of the hard disk 20 or to lock the hard disk 20 so that the computer system 5 cannot access the information of the hard disk 20. This shows that the externally connected hard disk drive described above, thought simple in its structure can achieve an excellent information security function.

As shown in FIGS. 1 and 4, the externally connected hard disk drive further comprises a cooling fan 7 mounted in the housing 1, the front board 10 of the housing 1 has a plurality of vent holes 101, and the back board 11 of the housing 1 has a plurality of vent holes 111. Thus, the externally connected hard disk drive has an excellent heat dissipating effect by the cooling fan 7 and the vent holes 101 and 111.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. An externally connected hard disk drive connected to a computer system by a signal line and connected to a power supply by an electric cord, comprising:
a housing having a front board and a back board;
a hard disk unit mounted in the housing and including a hard disk and a switch, wherein when the switch is turned on, the hard disk is accessible, and when the switch is turned off, the hard disk is inaccessible;
a mechanic lock mounted on front board of the housing and including a lock core, the lock core is arranged to be driven by a mating key to an unlocked position where the switch is turned on and a locked position where the switch is turned off.

2. The externally connected hard disk drive in accordance with claim 1, further comprising a cooling fan mounted in the housing, wherein the front board of the housing has a plurality of vent holes, and the back board of the housing has a plurality of vent holes.

3. An externally connected hard disk drive connected to a computer system by a signal line and connected to a power supply by an electric cord, comprising:
a housing having a front board and a back board;
an electric socket mounted on the back board of the housing and connected to the electric cord;
an interface adapter mounted on the back board of the housing and connected to the signal line;
a hard disk unit mounted in the housing and including a hard disk connected to the interface adapter and a switch connected to the electric socket, wherein when the switch is turned on, the hard disk is connected to the electric socket, and when the switch is turned off, a connection between the hard disk and the electric socket is interrupted;
a mechanic lock mounted on the front board of the housing and including a lock core, the lock core is arranged to be driven by a mating key to an unlocked position where the switch is turned on and a locked position where the switch is turned off.

4. The externally connected hard disk drive in accordance with claim 3, further comprising a cooling fan mounted in the housing, wherein the front board of the housing has a plurality of vent holes, and the back board of the housing has a plurality of vent holes.

5. An externally connected hard disk drive connected to a computer system by a signal line and connected to a power supply by an electric cord, comprising:
a housing having a front board and a back board;
an electric socket mounted on the back board of the housing and connected to the electric cord;
an interface adapter mounted on the back board of the housing and connected to the signal line;
a hard disk unit mounted in the housing and including a hard disk connected to the electric socket and a switch connected to the interface adapter, wherein when the switch is turned on, the hard disk is connected to the interface adapter, and when the switch is turned off, a connection between the hard disk and the interface adapter is interrupted;
a mechanic lock mounted on the front board of the housing and including a lock core, the lock core is arranged to be driven by a mating key to an unlocked position where the switch is turned on and a locked position where the switch is turned off.

6. The externally connected hard disk drive in accordance with claim 5, further comprising a cooling fan mounted in the housing, wherein the front board of the housing has a plurality of vent holes, and the back board of the housing has a plurality of vent holes.
